(19) United States
(12) Patent Application Publication
(10) Pub. No.: US 2015/0306795 A1
(43) Pub. Date: Oct. 29, 2015

(54) METHOD FOR MANUFACTURING COMPOUND DIAPHRAGM

(71) Applicant: Bingke Zhu, Shenzhen (CN)

(72) Inventor: Bingke Zhu, Shenzhen (CN)

(73) Assignee: AAC TECHNOLOGIES PTE. LTD., Singapore city (SG)

(21) Appl. No.: 14/510,235

(22) Filed: Oct. 9, 2014

(30) Foreign Application Priority Data
Apr. 25, 2014 (CN) 201410173074.5

(51) Int. Cl. B29C 43/00

(52) U.S. Cl. CPC B29C 43/003; B29K 2035/00

(57) ABSTRACT

The present disclosure provides a method for manufacturing a compound diaphragm. The method comprises the following steps: providing powdered graphene; providing macromolecular raw material; heating the macromolecular raw material to molten state; blending the macromolecular raw material in the molten state into the graphene and fully mixing them to obtain mixed slurry; and pressing the mixed slurry into the form of compound diaphragm through a tape casting process. The method for manufacturing a compound diaphragm provided in the present disclosure is simple and can provide a diaphragm with high strength and superior performances.

### FIELD OF THE INVENTION

The present disclosure relates to a method for manufacturing a compound diaphragm.

### DESCRIPTION OF RELATED ART

As driven by the market demand, mobile phones trends to be designed with low profile and are required to provide an increasingly better sound quality. For meeting this trend or requirement, the acoustic components used in the mobile phones should also be designed to develop towards a miniaturized volume, a low profile and high sound quality.

The diaphragm is known as a core element of an acoustic component such as a speaker, so the demand for acoustic performances of the diaphragms becomes also higher correspondingly.

The diaphragms in the related art are formed of a single cloth diaphragm or other materials, which can be hot-press molded, through a pressing process. However, the diaphragms of this structure tend to produce split vibration (unbalanced vibration) due to the insufficient stiffness of the diaphragms, and this leads to distortion and badly affects the hearing experience. Additionally, in practical applications, in order to enhance the strength of the diaphragms without affecting the sound quality, a common practice in the related art is to increase the thickness of partial areas of the diaphragms. However, the diaphragms formed of a single material have the same thickness throughout the diaphragms once being produced, so they cannot satisfy the aforesaid needs.

Accordingly, the present disclosure provides a novel compound diaphragm to overcome the aforesaid shortcomings.

### BRIEF DESCRIPTION OF THE DRAWINGS

FIG. 1 is a flowchart view of a process of manufacturing a compound diaphragm of the present disclosure.

### DETAILED DESCRIPTION OF THE INVENTION

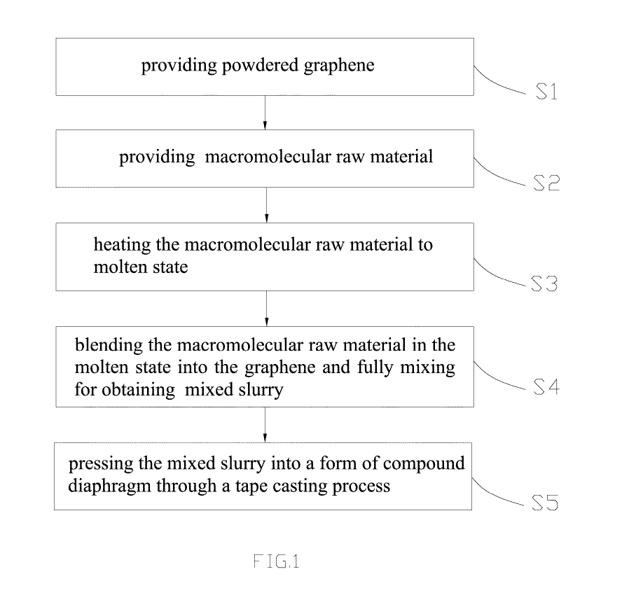

Hereinbelow, a method for manufacturing a compound diaphragm of the present disclosure will be described in detail. Referring to FIG. 1, a manufacturing method for a compound diaphragm comprises the following steps:

Step 1: providing powdered graphene;

Step 2: providing macromolecular raw material;

Step 3: heating the macromolecular raw material to a molten state;

Step 4: blending the macromolecular raw material in the molten state into the graphene and fully mixing them to obtain a mixed slurry; and

Step 5: pressing the mixed slurry into a form of compound diaphragm through a tape casting process.

The macromolecular raw material provided in the step 2 is a solid material. After heated to the molten state, the macromolecular raw material in the molten state is blended into the graphene and fully mixed with the graphene to obtain a mixed slurry. The macromolecular raw material is preferably in granulate or powder form. This can provide a large contact area so that the macromolecular raw material can be molten better. Preferably, a binder, a dispersant, a solvent or the like is added in mixed slurry and fully stirred and mixed to form a homogenous slurry. Then, the mixed slurry is tape cast after being de-foamed. Further, the compound diaphragm formed through tape casting is dried.

In the present disclosure, the macromolecular raw material may be any of polyetheretherketone (PEEK), polyethylene naphthalate (PEN), polyethylene terephthalate (PET), polyphenylene sulfide (PPS) or polyarylate (PAR).

Most preferably, PEEK is used because it features a high elasticity modulus and high abrasive resistance. Use of PEEK can enhance the strength and stiffness and improve the acoustic performances of the composite diaphragm.

The method for manufacturing a compound diaphragm of the present disclosure is simple, has a low production cost, and can provide a compound diaphragm with high strength and superior performances, and as compared to the conventional compound diaphragms, the compound diaphragm prepared by this method is more robust, stable and reliable. The compound diaphragm prepared by this method can be used in electroacoustic devices such as speakers and sound receivers.

While the present invention has been described with reference to the specific embodiments, the description of the invention is illustrative and is not to be construed as limiting the invention. Various of modifications to the present invention can be made to the exemplary embodiments by those skilled in the art without departing from the true spirit and scope of the invention as defined by the appended claims.

1. A method for manufacturing a compound diaphragm, comprising the following steps:
Step 1: providing powdered graphene;
Step 2: providing macromolecular raw material;
Step 3: heating the macromolecular raw material to molten state;
Step 4: blending the macromolecular raw material in the molten state into the graphene and fully mixing them for obtaining mixed slurry; and
Step 5: pressing the mixed slurry into a form of compound diaphragm through a tape casting process.

2. The method for manufacturing a compound diaphragm of claim 1, wherein the macromolecular raw material is granulated before being heated.

3. The method for manufacturing a compound diaphragm of claim 1, wherein the step 4 further comprises the following step: adding binder, dispersant and solvent into the mixed raw material and fully mixing them for forming homogeneous slurry.

4. The method for manufacturing a compound diaphragm of claim 3, wherein the step 5 further comprises the following step: tape-casting the mixed slurry after de-foaming the mixed slurry.

5. The method for manufacturing a compound diaphragm of claim 4, wherein the step 5 further comprises the following step: drying the composite diaphragm that is tape casted.

6. The method for manufacturing a compound diaphragm of claim 1, wherein the macromolecular raw material is any of polyetheretherketone, polyethylene naphthalate, polyethylene terephthalate, polyphenylene sulfide and polyarylate.
